(19) United States
(12) Patent Application Publication
(10) Pub. No.: US 2026/0301603 A1
(43) Pub. Date: Oct. 1, 2026

(54) CARDIOPULMONARY RESUSCITATION MANIKINS

(71) Applicant: PRESTAN PRODUCTS LLC, Solon, OH (US)

(72) Inventors: Christopher M. Charlton, Mint Hill, NC (US); Donald Steele Lydic, Mooresville, NC (US); Mark E. Cook, Lakewood Ranch, FL (US); Daniel R. Moon, Painesvile, OH (US); Christopher E. Bryniarski, Chesterland, OH (US)

(21) Appl. No.: 19/490,858

(22) PCT Filed: Jun. 6, 2024
(86) PCT No.: PCT/US2024/032788

§ 371 Date: Dec. 5, 2025

Related U.S. Application Data
(60) Provisional application No. 63/471,781, filed on Jun. 8, 2023.

(51) Int. Cl. G09B 23/28

(52) U.S. Cl. CPC G09B 23/288

(57) ABSTRACT

A cardiopulmonary resuscitation (“CPR”) manikin includes a torso defining one or more cavities, each of which can receive a removable appendage. The removable appendage includes a rigid body, an adapter housed within the rigid body at a proximal end thereof and defining a channel in an upper portion and a socket in a lower portion, and an outer skin layer. The socket receives one end of a socket pin having a latch and the other end of the socket pin is secured with one of the one or more cavities. Depression of a release pin, slidable within the channel, urges the latch out of the channel, to allow for removal of the socket pin from the socket.

### CROSS-REFERENCE TO RELATED APPLICATIONS

This patent application claims the benefit of U.S. Provisional Patent Application Ser. No. 63/471,781 filed on Jun. 8, 2023, and entitled Cardiopulmonary Resuscitation Manikins, the disclosure of which is hereby incorporated by reference herein in its entirety.

### TECHNICAL FIELD

The present application relates to cardiopulmonary resuscitation (“CPR”) manikins and methods for using the same. More specifically, the present application relates to CPR manikins with removable appendages.

### BACKGROUND

CPR manikins are medical training equipment used to teach healthcare professionals and lay responders medical procedures such as CPR. In particular, CPR manikins are replicas of humans on which such individuals may learn and practice these essential lifesaving skills. While conventional CPR manikins of adults may be limited to a head and torso with no limbs or appendages, conventional CPR manikins of children, particularly infants, may include a full body replica with appendages. CPR and other medical procedures for young children often involve holding, moving, and/or positioning appendages in a certain manner to facilitate care. Thus, providing a full body replica of a young child can help to replicate real-world situations and allow for accurate training. It can be difficult, however, to easily repair or replace damaged parts for such conventional CPR manikins for children. For example, if an appendage on a conventional CPR manikin becomes damaged or otherwise requires replacement, a full disassembly of the manikin may be required to access and replace the appendage, if not a full replacement of the manikin. What is desired is a CPR manikin that includes easily replaceable appendages that allow for efficient attachment to and detachment from a torso or main portion of the manikin.

### SUMMARY

In accordance with one embodiment, a CPR manikin comprises a torso defining a first joint cavity; a first socket pin having a first end and a second end, the first end configured for securement in the first joint cavity and the second end extending outwardly therefrom and including an outwardly-biased latch; and a first removable appendage. The first removable appendage comprises a rigid body defining a first opening; an adapter being housed within the rigid body at a proximal end thereof and defining a channel in an upper portion and a socket in a lower portion, the channel extending into the socket, and the socket configured to receive the second end of the first socket pin; a release pin slidable within the channel; and an outer skin layer substantially encapsulating the rigid body, adapter, and release pin. The second end of the first socket pin is releasably securable within the socket in a connected position, such that the latch extends into the channel. The second end of the first socket pin is releasable from the socket upon depression of the release pin when the second end of the first socket pin is in the connected position, such that the latch is urged out of the channel for removal of the second end of the first socket pin from the socket.

In accordance with another embodiment, a CPR manikin comprises a torso defining four cavities, the four cavities including two shoulder cavities and two hip cavities, wherein each of the cavities comprises a socket pin having a first end and a second end, the first end configured for securement in the respective cavity and the second end extending outwardly therefrom and including an outwardly-biased latch; and four removable appendages, the four removable appendages including two removable arms and two removable legs. Each of the removable appendages comprises a rigid body defining a first opening; an adapter being housed within the rigid body at a proximal end thereof and defining a channel in an upper portion and a socket in a lower portion, the channel extending into the socket, and the socket configured to receive the second end of the socket pin; a release pin slidable within the channel; and an outer skin layer substantially encapsulating the rigid body, adapter, and release pin. The second end of the socket pin is releasably securable within the socket in a connected position, such that the latch extends into the channel. The second end of the socket pin is releasable from the socket upon depression of the release pin when the second end of the socket pin is in the connected position, such that the latch is urged out of the channel for removal of the second end of the socket pin from the socket.

### BRIEF DESCRIPTION OF THE DRAWINGS

The present disclosure will be more readily understood from a detailed description of some example embodiments taken in conjunction with the following figures:

FIG. 1 depicts a perspective view of a CPR manikin of a child according to one embodiment;

FIG. 2 depicts a partially exploded view of the removable arm and an upper portion of a torso of the manikin of FIG. 1;

FIG. 3 depicts a perspective view of a removable arm of the manikin of FIG. 1;

FIG. 4 depicts an exploded view of the removable arm of FIG. 3;

FIG. 5 depicts an exploded view of an adapter and a socket pin from the removable arm depicted in FIG. 4;

FIG. 6 depicts a cross-sectional view of the adapter and the socket pin of FIG. 5;

FIG. 7 depicts another cross-sectional view of the adapter and the socket pin of FIG. 5, when a release pin is in a depressed position;

FIG. 8 depicts a partially exploded view of the removable leg and a lower portion of the torso of the manikin of FIG. 1; and

FIG. 9 depicts a perspective view of a removable leg of the manikin of FIG. 1;

FIG. 10 depicts an exploded view of the removable leg of FIG. 9; and

FIG. 11 depicts an exploded view of an adapter and a socket pin from the removable leg depicted in FIG. 10.

### DETAILED DESCRIPTION

For the purpose of the present description and of the appended claims, except where otherwise indicated, all numbers expressing amounts, quantities, percentages, and so forth, are to be understood as being modified in all instances by the term “about.” Also, all ranges include any combination of the maximum and minimum points disclosed and include any intermediate ranges therein, which may or may not be specifically enumerated herein.

The present disclosure, in at least one of the mentioned aspects, can be implemented according to one or more of the present embodiments, optionally combined together.

For the purpose of the present description and of the appended claims, the words “a” or “an” should be read to include one or at least one and the singular also includes the plural unless it is obvious that it is meant otherwise. This is done merely for convenience and to give a general sense of the disclosure.

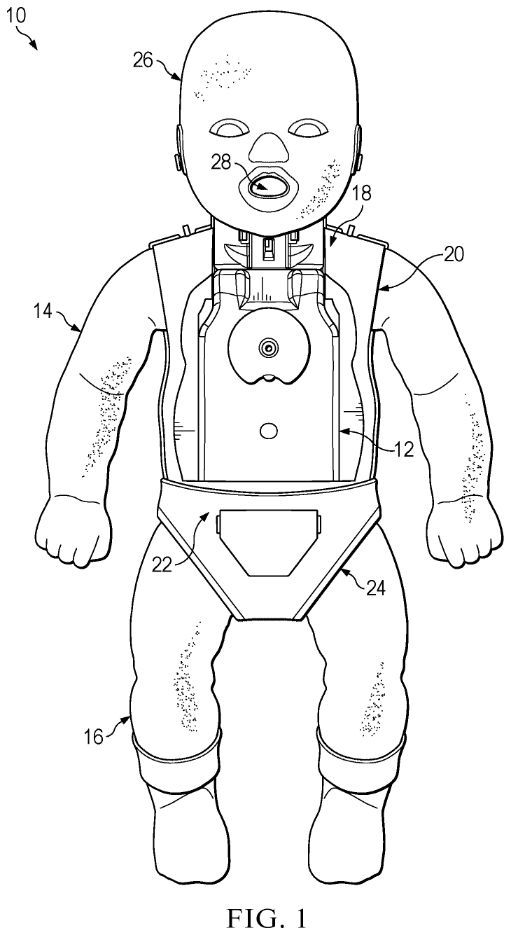

As will be described herein, CPR manikins are disclosed including appendages that allow for easy attachment to and detachment from a torso. FIG. 1, for example, shows a CPR manikin 10 having a torso 12 and multiple removable appendages (e.g., 14, 16). An upper portion 18 of the torso 12 can include two shoulder joints 20 to which two removable arms 14 may be releasably secured. A lower portion 22 of the torso 12 can include two hip joints 24 to which two removable legs 16 may be releasably secured. It will be appreciated, however, that any of a variety of other configurations can be employed for removable appendages on a CPR manikin. The CPR manikin 10 can also include a head 26 defining an airway opening 28 that leads to an internal chest cavity. In certain embodiments, the CPR manikin 10 can be configured to receive exhalations from an individual, such as a teacher or student practicing CPR methods; and in certain embodiments, the CPR manikin 10 can simulate an infant accepting such exhalations therein. It will further be appreciated that a CPR manikin can further include any of a variety of additional components and or systems for conducting CPR training as known in the art.

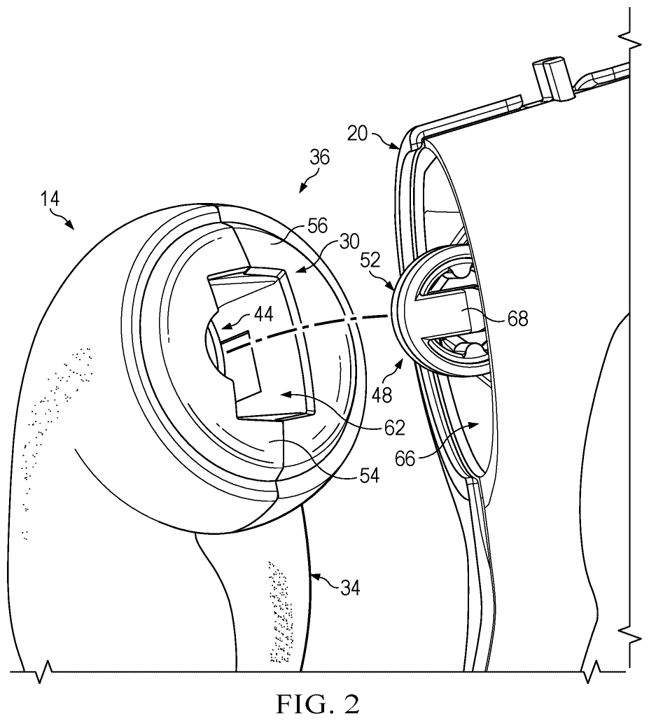

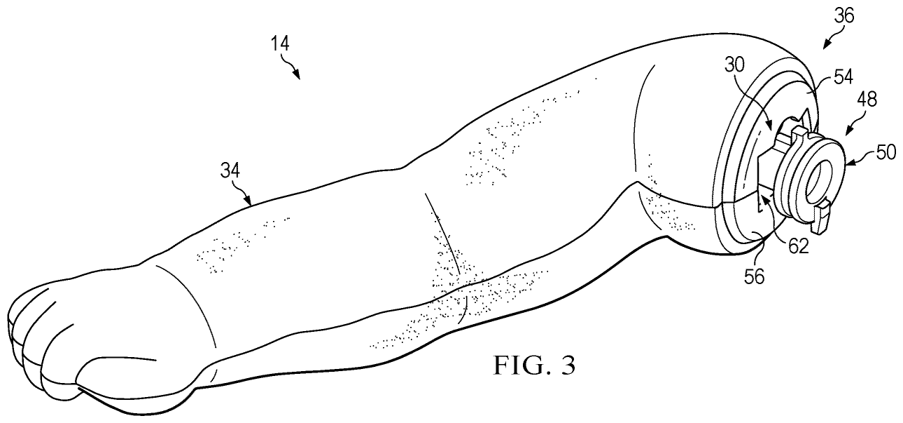

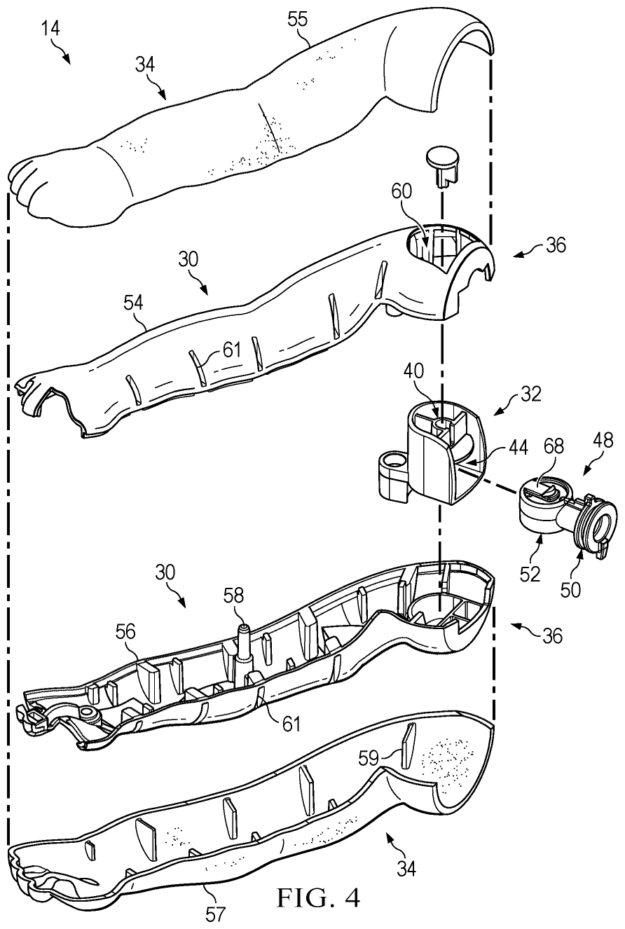

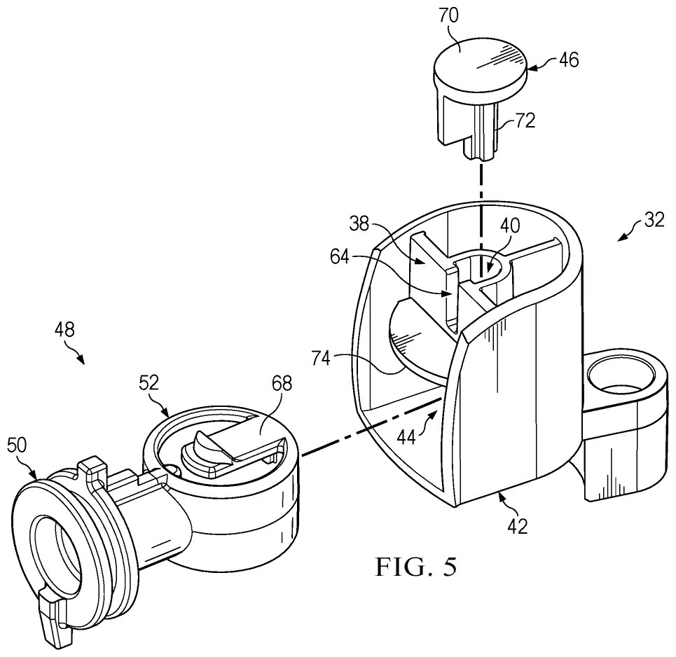

FIGS. 2-4 show a removable arm 14 according to one embodiment. In certain embodiments, the removable arm 14 can include a rigid body 30, an adapter 32 housed within the rigid body 30, and an outer skin layer 34 substantially encapsulating the rigid body 30. As shown in FIG. 4, the adapter 32 can be positioned at or near a proximal end 36 of the rigid body 30. In certain embodiments, and as best shown in FIG. 5, the adapter 32 can include an upper portion 38, in which a channel 40 is defined, and a lower portion 42, in which a socket 44 is defined. In certain embodiments, the channel 40 can be configured to receive a release pin 46. The channel 40 can be open at or near a top of the adapter 32, as shown in FIG. 5, and extend into the socket 44. In certain embodiments, the socket 44 can be open at or near a side of the adapter 32, as shown in FIG. 5, and configured to receive a socket pin 48. In certain embodiments, the socket pin 48 can include a first end 50, which can be secured within the shoulder joint 20, as best understood from FIGS. 2 and 3, and a second end 52, which can be releasably securable within the socket 44, as shown by FIGS. 2-7.

In certain embodiments, the rigid body 30 can be formed in two or more pieces (e.g., 54, 56) to facilitate insertion of the adapter 32, where the two or more pieces can be connectable by any of a variety of suitable means. For example, as shown in FIG. 4, the rigid body 30 can include a first portion 54 having at least one receiving member (not shown) and a second portion 56 having an at least one insertion member 58, such that the at least one receiving member can be configured to receive the at least one insertion member 58 to facilitate securement of the first and second portions 54, 56 to each other. It will be appreciated, however, that a rigid body can be provided in any suitable number of pieces in any of a variety of suitable configurations. In one embodiment, the rigid body 30 is formed of a plastic, but it will be appreciated that a rigid body can be provided in any of a variety of suitable materials.

The rigid body 30 can define at least one opening (e.g., 60, 62) as shown in FIG. 4. For example, the rigid body 30 can define a first opening 60 at or near the proximal end 36 of the rigid body 30, through which at least a portion of the adapter 32 may be accessible. In certain embodiments, the release pin 46 can extend from the adapter 32 into the first opening 60. As shown in FIG. 4, the first opening 60 may be defined by the first portion 54 of the rigid body 30, but it will be appreciated that a first opening can be defined by any suitable portion or portions of a rigid body. The rigid body 30 can further define a second opening 62 at or near the proximal end 36 of the rigid body 30, through which the second end 52 of the socket pin 48, for example, can access the socket 44 for insertion therein. Referring to FIGS. 2-4, the second opening 62 may be defined by the first portion 54 and the second portion 56 of the rigid body 30. It will be appreciated, however, that a second opening can be defined by any suitable portion or portions of a rigid body.

As shown in FIG. 5, the adapter 32 can further define a slot 64 along at least a portion of the channel 40. In certain embodiments, the release pin 46, when at least partially positioned in channel 40, can be visible through the slot 64. In such embodiments, where the release pin 46 is visible through the slot 64, the release pin 46 can further be visible through the second opening 62. For example, and as shown in FIGS. 2-4, the second opening 62, as defined by the first portion 54 and the second portion 56 of the rigid body 30, can have a substantially rectangular perimeter with a semicircular recess included therein. In such embodiments, the slot 64, and when at least partially positioned in channel 40, the release pin 46 can be visible through, at least, the semicircular recess defined in the perimeter of the second opening 62. Maintaining visibility of the slot 64 through the second opening 62 can allow for confirmation of the presence of a release pin 46, such that the removable arm 14 can function as expected. It will be appreciated, however, that a perimeter of a second opening can be any of a variety of suitable shapes or configurations.

In certain embodiments, the outer skin layer 34 can substantially encapsulate or surround the rigid body 30, the adapter 32, and the release pin 46. As with the rigid body 30, the outer skin layer 34 can be formed in two or more pieces (e.g., 55, 57), where the two or more pieces can be connectable by any of a variety of suitable means. As shown in FIG. 4, for example, the outer skin layer 34 can include a first portion 55 and a second portion 57, each of which can include at least one second insertion member 59 that aligns with a corresponding second receiving member 61 on an outer surface of the rigid body 30. The second receiving members 61 can be configured to receive the corresponding second insertion members 59 to facilitate securement of the first and second portions 55, 57 around the rigid body 30. It will be appreciated, however, that an outer skin layer can be provided in any suitable number of pieces in any of a variety of suitable configurations.

In certain embodiments, the outer skin layer 34 can be formed from a flexible material, such as an elastomeric material, but it will be appreciated that an outer skin layer can be provided in any of a variety of suitable materials. In some embodiments, the outer skin layer 34 can exhibit a hardness of about 70 durometer to about 90 durometer. Referring to FIGS. 2-4, the outer skin layer 34 can closely adhere and conform to the rigid body 30, such that the outer skin layer 34 can be at least partially supported by the same. As the outer skin layer 34 can substantially encapsulate or surround the rigid body 30, the outer skin layer 34 can completely cover the first opening 60. Without the rigidity of the rigid body 30 providing support, the flexibility of the outer skin layer 34 can be more fully realized at or near the first opening 60. For example, at least a portion of the outer skin layer 34 at the first opening 60 may be pressed into the same. In such embodiments, the release pin 46 can be accessible for depression by pressing the outer skin layer 34 into the first opening 60. As shown in FIGS. 2-4, however, at least a portion of the proximal end 36 of the rigid body 30 can remain exposed, such that the outer skin layer 34 does not cover the second opening 62. In such embodiments, the socket 44 can be accessible to receive the second end 52 of the socket pin 48.

As shown in FIG. 2, the shoulder joint 20 can define a shoulder joint cavity 66 into which at least a portion of the proximal end 36 of the removable arm 14 may be inserted. In certain embodiments, the proximal end 36 of the removable arm 14 can have a convex shape and the shoulder joint cavity 66 can be configured to receive the proximal end 36 of the removable arm 14. FIG. 2 also shows the socket pin 48 secured within the shoulder joint cavity 66 at its first end 50, such that the second end 52 of the socket pin 48 remains exposed, extending outwardly from the shoulder joint cavity 66 and available for insertion into the socket 44 through the second opening 62. Referring to FIGS. 1 and 2, for example, the proximal end 36 of the removable arm 14 can be directed into the shoulder joint cavity 66 as the second end 52 of the socket pin 48 can extend into the socket 44 to releasably connect the removable arm 14 to the torso 12 at the shoulder joint 20. In certain embodiments, the removable arm 14 can be at least partially rotatable relative to the torso 12 when in a connected position. Providing for rotation and movement of the removable appendages (e.g. 14, 16) can facilitate simulation of an infant's mobility and thus, allow for more accurate instruction of CPR methods. It will be appreciated that a proximal end of a removable arm and a shoulder joint cavity can be provided in any of a variety of respective shapes and configurations to allow for such relative movement.

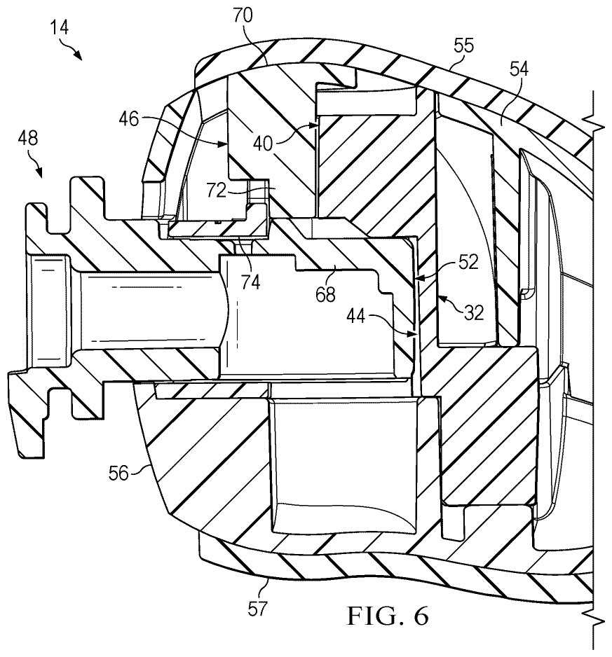

Referring back to FIG. 5, the second end 52 of the socket pin 48 can include an outwardly-biased latch 68. Upon sufficient insertion of the second end 52 of the socket pin 48 into the socket 44, the outward bias of the latch 68 can cause the latch 68 to extend into the channel 40, thereby establishing securement of the removable arm 14 to the torso 12. As best shown in FIG. 6, which depicts an interior of the adapter 32, nesting of the latch 68 within the channel 40, when the socket pin 48 is secured within the socket 44 in the connected position, can help to prevent separation of the removable arm 14 from the torso 12, such that latch 68 will be obstructed by an interior of the channel 40 upon an attempt to remove the socket pin 48 from the socket 44.

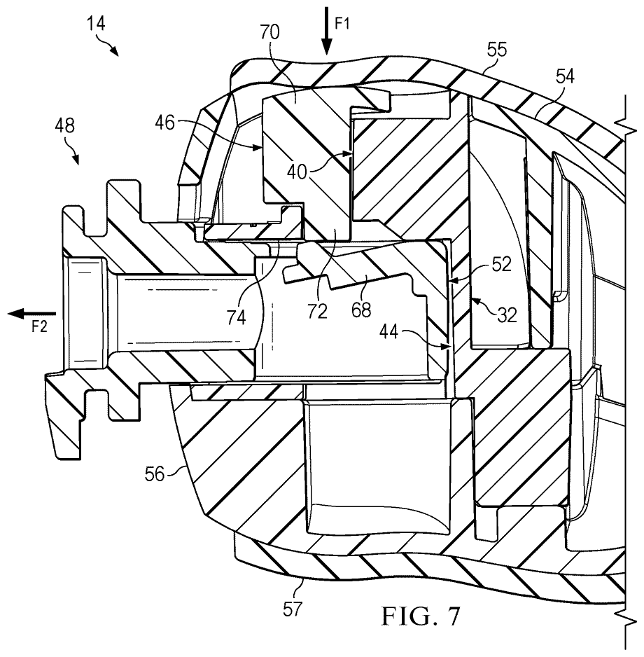

As described herein, the removable arms 14 may be releasably secured to the torso 12, such that the second end 52 of the socket pin 48 can be detachable from the socket 44. Like FIG. 6, FIG. 7 also depicts the interior of the adapter 32, but with a force F1 being exerted on a portion of the outer skin layer 34 covering the release pin 46, as indicated by a downward arrow. As shown in FIGS. 6 and 7, for example, the release pin 46 can include an upper head portion 70 and a lower portion 72. The upper head portion 70 of the release pin 46 can include a larger surface area, relative to the lower portion 72, to facilitate depression of the same. The lower portion 72 of the release pin 46 can be slidable within the channel 40. In some embodiments, the lower portion 72 of the release pin 46 can be substantially or at least partially cylindrical. An upper surface 74 of the socket 44 can define an upper socket plane at which the channel 40 and socket 44 intersect. In certain embodiments, the channel 40 can define a longitudinal axis that is substantially perpendicular to the first socket plane. Referring back to FIG. 7, the force F1 applied to the outer skin layer 34, with the second end 52 of the socket pin 48 in the connected position, can urge the release pin 46 downwards, such that the release pin 46 can contact the latch 68 and urge it downwards until the latch 68 moves below the upper socket plane and out of the channel 40. With the release pin 46 depressed, the second end 52 of the socket pin 48 can be pulled out of the socket 44—i.e., via force F2—without the latch 68 being obstructed by the interior of the channel 40. In certain embodiments, the second end 52 of the socket pin 48 can be substantially cylindrical and define a second longitudinal axis. In such embodiments, the first and second longitudinal axes can be substantially parallel, and in certain embodiments, with the second end 52 of the socket pin 48 in the connected position, the first and second longitudinal axes can be substantially coincident.

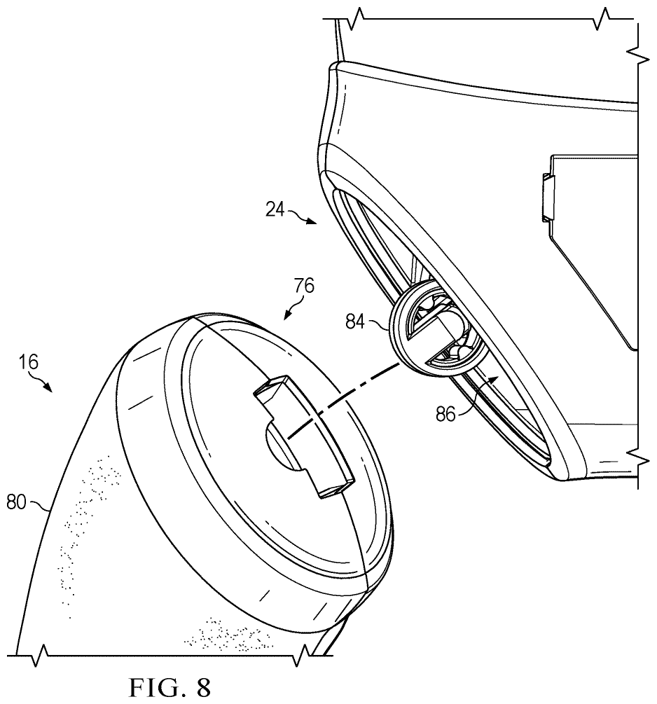

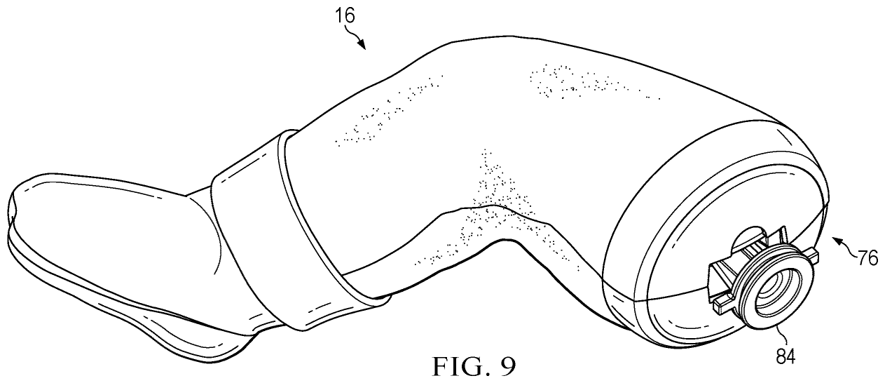

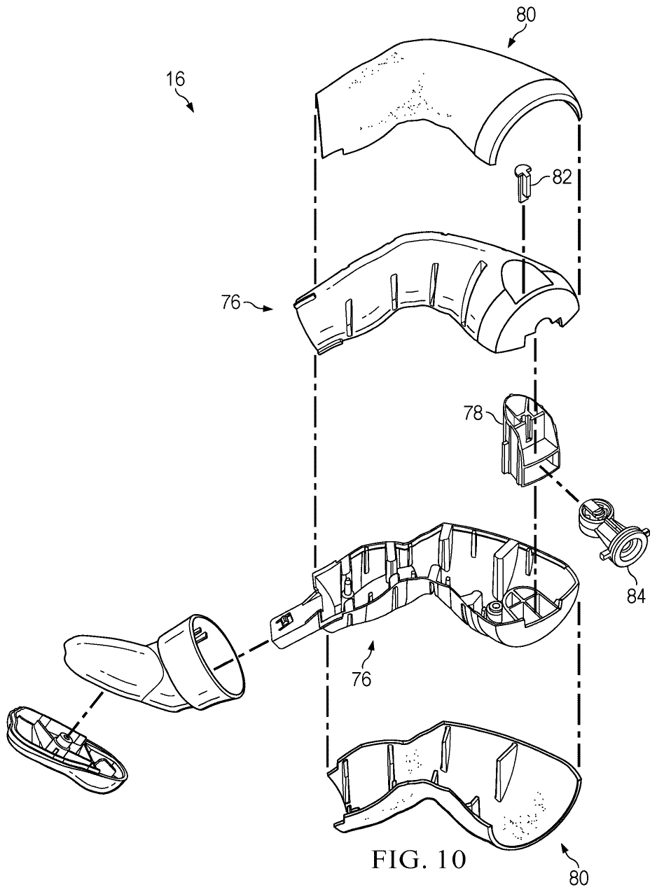

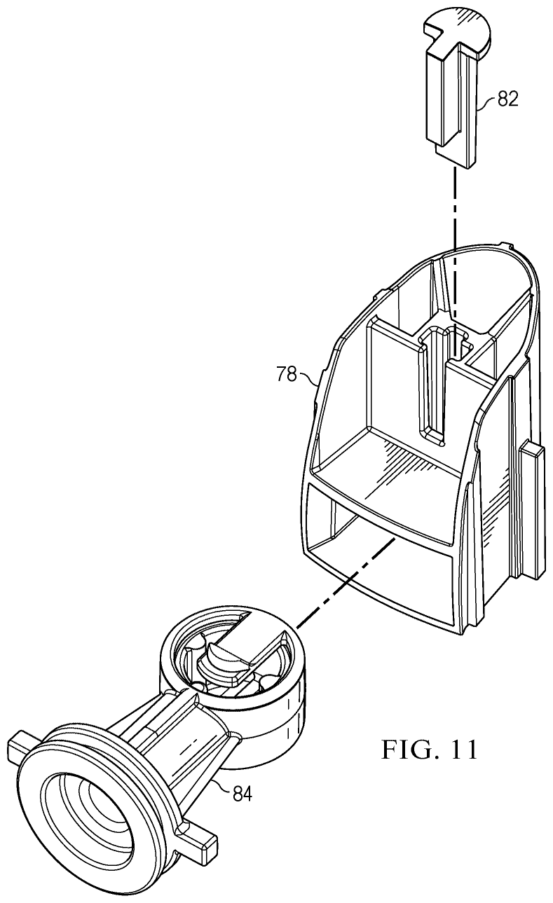

FIGS. 8-10 show a removable leg 16 according to one embodiment. In certain embodiments, the removable leg 16 and components thereof can be constructed in the same manner as the removable arm 14 and components thereof, as described herein. For example, as shown in FIG. 10, the removable leg 16 can also include a rigid body 76, an adapter 78 housed within the rigid body 76, and an outer skin layer 80 substantially encapsulating the rigid body 76. Similarly, as best shown in FIG. 11, the adapter 78 for the removable leg 16 can be constructed similarly to the adapter 32 for the removable arm 14, as described herein. In certain embodiments, the adapter 78 for the removable leg 16 can be sized or shaped differently than the adapters 32 for the removable arm 14. Accordingly, other leg-related components, such as a release pin 82 and a socket pin 84, can also be sized or shaped differently than its corresponding components for the removable arm 14 (i.e., 46, 48, respectively). In such embodiments, the different sizing and/or shapes can help to avoid misplacement of various components. For example, in such embodiments, an adapter 78 may be constructed such that it only fits in a removable leg 16 and not a removable arm 14.

As shown in FIG. 8, the hip joint 24 can define a hip joint cavity 86 into which at least a portion of a proximal end 88 of the removable arm 16 may be inserted. Referring to FIG. 8, the socket pin 84 can be secured within the hip joint cavity 86 with a portion thereof remaining exposed, extending outwardly from the hip joint cavity 86 and available for insertion into the removable arm 16 in the same manner as socket pin 48 can be releasably securable to the removable arm 14, as described herein. Similarly, in certain embodiments, the removable leg 16 can be at least partially rotatable relative to the torso 12 when in a connected position. Nonetheless, it will be appreciated that a proximal end of a removable leg and a hip joint cavity can be provided in any of a variety of respective shapes and configurations to allow for such relative movement.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A cardiopulmonary resuscitation (“CPR”) manikin, comprising:
a torso defining a first joint cavity;
a first socket pin having a first end and a second end, the first end configured for securement in the first joint cavity and the second end extending outwardly therefrom and including an outwardly-biased latch; and
a first removable appendage, comprising:
a rigid body defining a first opening;
an adapter being housed within the rigid body at a proximal end thereof and defining a channel in an upper portion and a socket in a lower portion, the channel extending into the socket, and the socket configured to receive the second end of the first socket pin;
a release pin slidable within the channel; and
an outer skin layer substantially encapsulating the rigid body, adapter, and release pin;
wherein the second end of the first socket pin is releasably securable within the socket in a connected position, such that the latch extends into the channel; and
wherein the second end of the first socket pin is releasable from the socket upon depression of the release pin when the second end of the first socket pin is in the connected position, such that the latch is urged out of the channel for removal of the second end of the first socket pin from the socket.

2. The manikin of claim 1, wherein the release pin is accessible for depression by pressing the outer skin layer into the first opening.

3. The manikin of claim 2, wherein the release pin extends into the first opening.

4. The manikin of claim 1, wherein the proximal end of the rigid body defines a second opening through which the socket is accessible.

5. The manikin of claim 4, wherein the proximal end comprises a convex shape; and wherein the first joint cavity is configured to receive the proximal end.

6. The manikin of claim 4, wherein the adapter further defines a slot along at least a portion of the channel.

7. The manikin of claim 6, wherein at least a portion of the release pin is visible through the slot.

8. The manikin of claim 7, wherein at least a portion of the release pin is visible through the second opening of the rigid body.

9. The manikin of claim 1, wherein an upper surface of the first socket defines a first socket plane; wherein the channel defines a first longitudinal axis; and wherein the longitudinal axis of the channel extends substantially perpendicular to the first socket plane.

10. The manikin of claim 9, wherein the second end of the first socket pin is substantially cylindrical and defines a second longitudinal axis; wherein the first and second longitudinal axes are substantially parallel or coincident.

11. The manikin of claim 10, wherein the first removable appendage is at least partially rotatable relative to the torso.

12. The manikin of claim 1, wherein the outer skin layer is formed from an elastomeric material.

13. The manikin of claim 1, wherein the outer skin layer exhibits a hardness of about 70 durometer to about 90 durometer.

14. The manikin of claim 1, wherein the first joint cavity is a shoulder cavity and the first removable appendage is a removable arm.

15. The manikin of claim 14, comprising two shoulder cavities and two removable arms.

16. The manikin of claim 1, further comprising a second joint cavity, the second joint cavity being a hip cavity; and a second removable appendage, the second removable appendage being a removable leg.

17. The manikin of claim 16, comprising two hip cavities and two removable legs.

18. A cardiopulmonary resuscitation CPR manikin, comprising:
a torso defining four cavities, the four cavities including two shoulder cavities and two hip cavities, wherein each of the cavities comprises a socket pin having a first end and a second end, the first end configured for securement in the respective cavity and the second end extending outwardly therefrom and including an outwardly-biased latch; and
four removable appendages, the four removable appendages including two removable arms and two removable legs, wherein each of the removable appendages comprises:
a rigid body defining a first opening;
an adapter being housed within the rigid body at a proximal end thereof and defining a channel in an upper portion and a socket in a lower portion, the channel extending into the socket, and the socket configured to receive the second end of the socket pin;
a release pin slidable within the channel; and
an outer skin layer substantially encapsulating the rigid body, adapter, and release pin;
wherein the second end of the socket pin is releasably securable within the socket in a connected position, such that the latch extends into the channel; and
wherein the second end of the socket pin is releasable from the socket upon depression of the release pin when the second end of the socket pin is in the connected position, such that the latch is urged out of the channel for removal of the second end of the socket pin from the socket.

19. The manikin of claim 18, wherein the adapter further defines a slot along at least a portion of the channel, at least a portion of the release pin being visible through the slot;
wherein the proximal end of the rigid body comprises a convex shape and defines a second opening through which the socket is accessible and at least a portion of the release pin is visible; and
wherein each of the two shoulder cavities is configured to receive the proximal end of one of the two removable arms and each of the two hip cavities is configured to receive the proximal end of one of the two removable legs.

20. The manikin of claim 18, wherein adapters of the removable arms are sized or shaped differently than adapters of the removable legs.
